(19) United States
(12) Patent Application Publication
(10) Pub. No.: US 2019/0384553 A1
(43) Pub. Date: Dec. 19, 2019

(54) PRODUCTION INTEGRATED MANAGEMENT SYSTEM FOR PRINTED MATERIAL, PRODUCTION INTEGRATED MANAGEMENT APPARATUS FOR PRINTED MATERIAL, AND NON-TRANSITORY COMPUTER READABLE MEDIUM

(71) Applicant: FUJI XEROX CO., LTD., Tokyo (JP)

(72) Inventors: Jun WAKAMATSU, Kanagawa (JP); Hiroyoshi NAKAYAMA, Kanagawa (JP)

(73) Assignee: FUJI XEROX CO., LTD., Tokyo (JP)

(21) Appl. No.: 16/352,864

(22) Filed: Mar. 14, 2019

(30) Foreign Application Priority Data
Jun. 13, 2018 (JP) 2018-112883

(51) Int. Cl. G06F 3/12

(52) U.S. Cl. CPC G06F 3/1262; G06F 3/1259; G06F 3/1203

(57) ABSTRACT

A production integrated management system for a printed material includes plural step management apparatuses that manage respective steps of a series of steps that constitute a printed material production process; and an integrated management apparatus that manages a job process in the printed material production process in an integrated manner on a basis of reports from the respective step management apparatuses. The integrated management apparatus includes: a sheet generating unit that generates a job process management sheet for management of all of the series of steps every time a printed material job is received in an initial one of the series of steps; and an adding unit that adds a status record to the job process management sheet on a basis of status information included in the reports from the respective step management apparatuses.

### CROSS-REFERENCE TO RELATED APPLICATIONS

This application is based on and claims priority under 35 USC 119 from Japanese Patent Application No. 2018-112883 filed Jun. 13, 2018.

### BACKGROUND

### (i) Technical Field

The present disclosure relates to a production integrated management system for a printed material, a production integrated management apparatus for a printed material, and a non-transitory computer readable medium.

### (ii) Related Art

For example, a series of steps that constitute a printed material production process are constituted by a manuscript submission step, a preprocessing (prepress) step, a print (press) step, a postprocessing (postpress) step, and a delivery step. The manuscript submission step, the preprocessing step, and part of the print step are basically electronic processes, and part of the print step, the postprocessing step, and the delivery step are basically mechanical processes (processes performed after a print result is obtained). The processes in the respective steps are performed as follows. Each of operators in charge of the respective steps receives a job procedure sheet (a physical sheet) and an intermediate object from an operator in charge of a previous step, processes the intermediate object in accordance with the job procedure sheet, puts, for example, a check mark indicative of process completion on the job procedure sheet by handwriting, and gives the job procedure sheet and the processed intermediate object to a next step. In this way, various kinds of printed materials are produced.

Some of the series of steps are sometimes managed in an integrated manner. For example, in a workflow system related to printed material production work, information is shared by using an industry-standard document format called a job definition format (JDF) that allows information to be shared among the steps and a communication format called a job messaging format (JMF) for communication of a work progress situation in the workflow system using the JDF and information on change of specifications. Furthermore, information in the steps is managed in an integrated manner by using a management information system (MIS). This achieves an improvement in work efficiency. Japanese Unexamined Patent Application Publication No. 2010-113673 and Japanese Unexamined Patent Application Publication No. 2017-219944 have descriptions about an MIS. Conventionally, an MIS does not manage all of the series of steps in an integrated manner and merely manages some of the series of steps.

### SUMMARY

There are needs for integrated management of all of a series of steps (a combination of electronic processes and mechanical processes) that constitute a printed material production process. A mechanism that allows flexible recording according to various printed material production specifications and allows information concerning a job (printed material job) to be handled for each job is desired.

Aspects of non-limiting embodiments of the present disclosure relate to making it possible to collectively handle, for each printed material job, management information concerning a series of steps that constitute a printed material production process and record the information flexibly in accordance with various printed material production specifications.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a production integrated management system for a printed material includes plural step management apparatuses that manage respective steps of a series of steps that constitute a printed material production process; and an integrated management apparatus that manages a job process in the printed material production process in an integrated manner on a basis of reports from the respective step management apparatuses. The integrated management apparatus includes: a sheet generating unit that generates a job process management sheet for management of all of the series of steps every time a printed material job is received in an initial one of the series of steps; and an adding unit that adds a status record to the job process management sheet on a basis of status information included in the reports from the respective step management apparatuses.

### BRIEF DESCRIPTION OF THE DRAWINGS

An exemplary embodiment of the present disclosure will be described in detail based on the following figures, wherein:

FIG. 1 is a block diagram illustrating a series of steps that constitute a printed material production process and an outline of a configuration of a production integrated management system;

FIG. 2 is a block diagram illustrating an example of constituents of each step and an example of a connection relationship between step management apparatuses and an integrated management apparatus;

FIG. 3 illustrates an example of a job process management sheet after completion of a manuscript submission step;

FIG. 4 illustrates an example of a job process management sheet during a preprocessing step;

FIG. 5 illustrates an example of a job process management sheet after completion of the preprocessing step;

FIG. 6 illustrates an example of a job process management sheet during the print step;

FIG. 7 illustrates an example of a job process management sheet after completion of the print step;

FIG. 8 illustrates an example of a job process management sheet after completion of a postprocessing step;

FIG. 9 illustrates an example of a job process management sheet after completion of a delivery step;

FIG. 10A illustrates an example of interleaving paper given an RFID tag, and FIG. 10B illustrates a banner page given a code; and

FIG. 11 illustrates an example of a print result material and interleaving paper output to a paper output tray of a printer.

### DETAILED DESCRIPTION

An exemplary embodiment of the present disclosure is described with reference to the drawings.

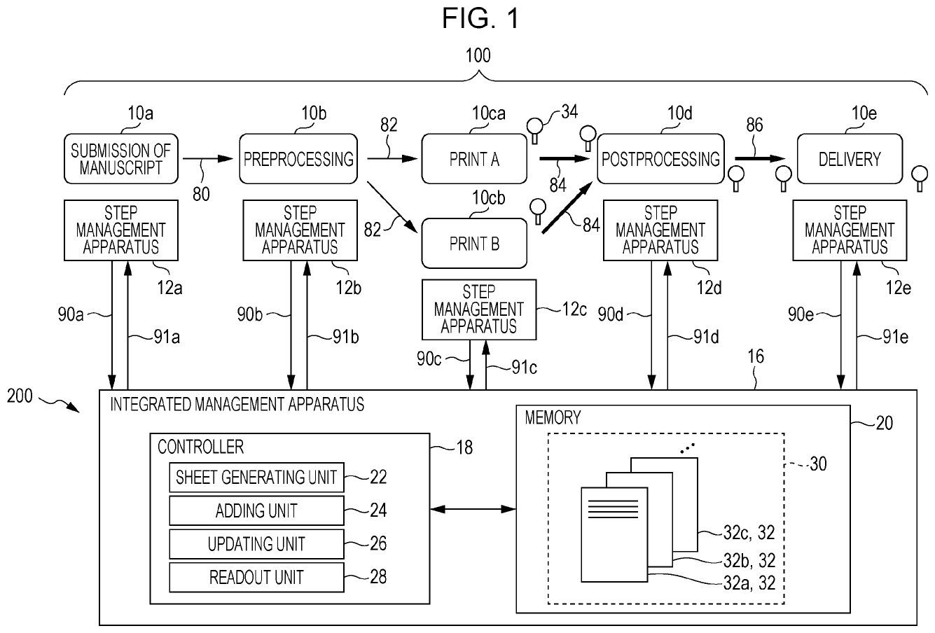

FIG. 1 is a block diagram illustrating a series of steps 100 that constitute a printed material production process and an outline of a configuration of a production integrated management system 200 for a printed material. The series of steps 100 can be called a workflow and are constituted by a manuscript submission step 10a, a preprocessing (prepress) step 10b, print (press) steps 10ca and 10cb, a postprocessing (postpress) step 10d, and a delivery step 10e. The production integrated management system 200 manages the series of steps 100 in an integrated manner.

First, each of the series of steps 100 is briefly described. In the manuscript submission step 10a, a printed material job 80 is created on the basis of a printed material production request (e.g., production specifications and image data) from a client.

In the preprocessing step 10b, processing such as imposition is performed on the basis of the printed material job 80 received from the manuscript submission step 10a. In the case of offset printing, a printing plate and the like are created. In the preprocessing step 10b, in a case where a requested printed material is, for example, a book, component jobs for a “front cover”, a “body”, and a “belly band” are separately created. In the preprocessing step 10b, a group job may be created by grouping component jobs. However, in the present exemplary embodiment, a single component job is handled as a single group job 82 for simplification of description. That is, in the above example, a group job 82 for the “front cover”, a group job 82 for the “body”, and a group job 82 for the “belly band” are created. Furthermore, in the preprocessing step 10b, a specific one of plural printers is allocated to each of the group jobs 82. This allocating process may be performed in the print step described next.

In the print steps 10ca and 10cb, printing is executed on the basis of the group jobs 82 received from the preprocessing step 10b. In FIG. 1, two parallel print steps 10ca and 10cb are illustrated. This indicates that printing is executed in parallel by two printers. For example, in the above example, the group job for the “body” is processed by a printer B (corresponding to the print step 10cb) while the group job for the “front cover” is being processed by a printer A (corresponding to the print step 10ca). The number of printers may be 1 or may be three or more.

In the postprocessing step 10d, cutting, bending, stapling, and the like are executed on print results received from the print steps 10ca and 10cb. In the above example, group print results 84 corresponding to the group jobs 82 for the “front cover”, the “body”, and the “belly band” are combined in the postprocessing step 10d, and thus a printed material (e.g., a book) is completed.

In the delivery step 10e, a printed material 86 is delivered, for example, to the client. This delivery step 10e includes, for example, conveying the printed material 86 to a delivery truck, for example, by using a belt conveyor.

Each step has been briefly described above, but contents of each step vary depending on production specifications of a printed material. The postprocessing step is unnecessary depending on a printed material. Some printed materials are constituted by a large number of components. In such a case, it is necessary to print each of the components and combine the components. Furthermore, in recent years, a printed material is often produced in a small lot, and contents of each step frequently change depending on a produced printed material. Contents of a preprocessing step and a print step change markedly depending on whether a used printing method is offset printing or digital printing (on-demand printing).

Even in a case where contents of each step change markedly depending on a printed material to be produced (print result job), the production integrated management system 200 described below can manage the series of steps in an integrated manner. The production integrated management system 200 is described in detail below.

As illustrated in FIG. 1, the production integrated management system 200 includes step management apparatuses 12a, 12b, 12c, 12d, and 12e that manage the series of steps 10a, 10b, 10ca (cb), 10d, and 10e that constitute a printed material production process and an integrated management apparatus 16 that manages job processes in the printed material production process in an integrated manner on the basis of reports 90a, 90b, 90c, 90d, and 90e received from these step management apparatuses.

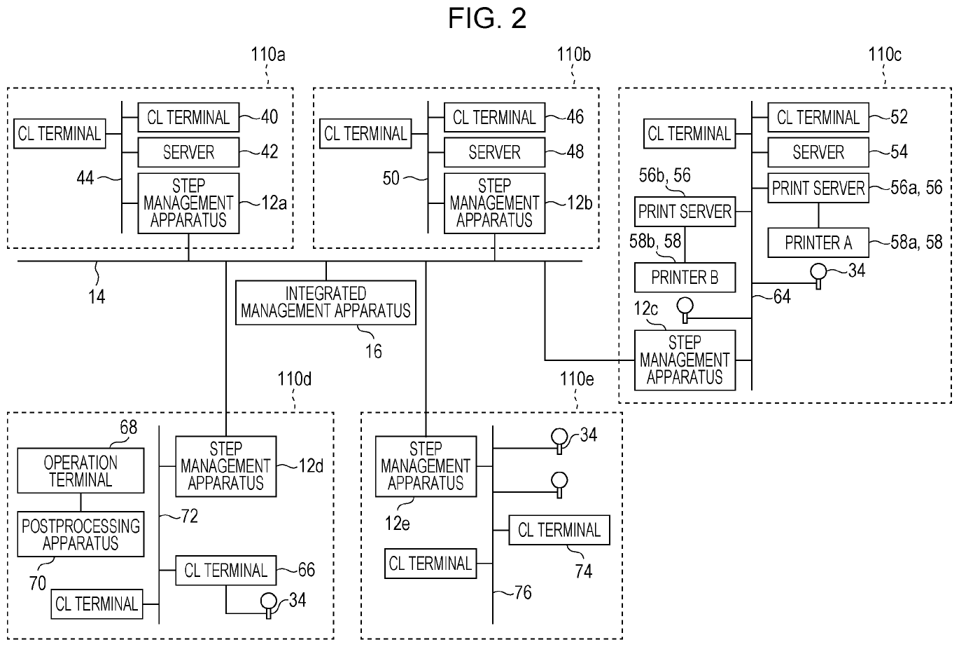

The integrated management apparatus 16 is an information processing apparatus that includes a controller 18 and a memory 20. The controller 18 includes a processor such as a CPU and performs information processing in accordance with a program installed in the integrated management apparatus 16. This causes the controller 18 to function as a sheet generating unit 22, an adding unit 24, an updating unit 26, and a readout unit 28. The sheet generating unit 22, the adding unit 24, the updating unit 26, and the readout unit 28 correspond to a sheet generating unit, an adding unit, an updating unit, and a readout unit, respectively. The memory 20 is a hard disk or the like and stores therein a program executed by the controller 18 and a management database 30. The management database 30 is constituted by one or more job process management sheets 32. A single job process management sheet 32 is prepared for each printed material job. Details of this will be described later. The integrated management apparatus 16 has a network interface (not illustrated) as a means of communication and is connected to a network 14 (see FIG. 2). The integrated management apparatus 16 can be also called a production integrated management apparatus.

FIG. 2 is a block diagram illustrating an example of constituents of each step and an example of a connection relationship between the step management apparatuses 12a, 12b, 12c, 12d, and 12e and the integrated management apparatus 16. As illustrated in FIG. 2, the step management apparatuses 12a, 12b, 12c, 12d, and 12e are provided for the respective steps. These step management apparatuses are information processing apparatuses that collectively manage information in the respective steps. Although a step management apparatus is provided for each step in FIG. 2, a step management apparatus common to plural steps may be provided. Each step management apparatus has a controller (not illustrated), a memory, and the like. The controller includes a processor such as a CPU and performs information processing in accordance with a program installed in the step management apparatus. The memory is a hard disk or the like and stores therein a program executed by the controller and the like. The step management apparatus has a network interface (not illustrated) as a means of communication and is connected to the network 14.

The programs used in the integrated management apparatus 16 and the step management apparatuses 12a, 12b, 12c, 12d, and 12e may be provided not only by a means of communication, but also by being stored in a computer-readable recording medium such as a CD-ROM or a USB memory. The programs provided by a means of communication or a recording medium are installed in the apparatuses (computers).

As illustrated in FIG. 2, the integrated management apparatus 16 and the step management apparatuses 12a, 12b, 12c, 12d, and 12e are connected through the network 14 such as a LAN or the Internet. The step management apparatuses 12a, 12b, 12c, 12d, and 12e report (transmit) processing information of a printed material job to the integrated management apparatus 16 over the network 14. Upon receipt of the processing information, the integrated management apparatus 16 records the processing information on the job process management sheet 32 for a corresponding printed material job. Furthermore, each of the step management apparatuses 12a, 12b, 12c, 12d, and 12e transmits a request to read out the job process management sheet 32 for a specific printed material job over the network 14. Upon receipt of the request, the integrated management apparatus 16 reads out the job process management sheet 32 for the corresponding printed material job and transmits contents of the job process management sheet 32 to the step management apparatus that has transmitted the request over the network 14. The JDF or JMF may be used for communication between each step management apparatus and the integrated management apparatus 16.

The following describes an example of constituents 110a, 110b, 110c, 110d, and 110e of the respective steps with reference to FIG. 2. First, what is common to the constituents of the respective steps is described. Constituents of each of the steps include a step management apparatus and one or more client terminals (CL terminals) connected to the step management apparatus over a network. Information such as status information supplied from the client terminal and contents of execution in a step is collected in the step management apparatus. The step management apparatus collects these pieces of information and reports (transmits) these pieces of information to the integrated management apparatus 16. Furthermore, constituents of each of the steps include a device such as a server necessary for work in the step. The necessary device or apparatus varies depending on a printing method or the like. Plural devices or apparatuses of the same kind or different kinds are sometimes provided depending on a requested amount of processing or the kind of processing. In FIG. 2, an example of constituents in the case of digital printing (on-demand printing) is illustrated.

Next, constituents of each of the individual steps are described. As illustrated in FIG. 2, the constituents 110a of the manuscript submission step include plural client terminals 40, a server 42, and the step management apparatus 12a, which are connected over a network 44 such as a LAN. For example, the client terminals 40 access the server 42, and a printed material job 80 is generated on the basis of a production request (e.g., production specifications and image data).

The constituents 110b of the preprocessing step include plural client terminals 46, a server 48, and the step management apparatus 12b, which are connected over a network 50 such as a LAN, as in the case of the constituents 110a of the manuscript submission step. For example, the printed material job 80 is stored in the server 48, the client terminals 46 access the server 48, and processing such as imposition is performed on the basis of the printed material job 80. Furthermore, group jobs described above are generated. The server 42 in the manuscript submission step, the server 48 in the preprocessing step, and a server 54 in the printing step that will be described later may be configured to be capable of exchanging data over a network (not illustrated).

The constituents 110c of the printing step include plural client terminals 52, the server 54, the step management apparatus 12c, and plural print servers 56a and 56b, which are connected through a network 64 such as a LAN. Printers 58a and 58b are connected to the print servers 56a and 56b, respectively. For example, a print job (group job) is stored in the server 54, the print job is read out by operating the server 54 by using the client terminal 52 and is supplied to the print server 56a or 56b, and a print result (group print result) is output from the printer 58a or 58b. Each of the keyhole-shaped marks illustrated in Fids. 1 and 2 represents a reader 34 for reading an RFID tag or a code that will be described later. The constituents 110c of the printing step include one or more readers 34.

The constituents 110d of the postprocessing step include plural client terminals 66, the step management apparatus 12d, a postprocessing apparatus 70, and an operation terminal 68 for the postprocessing apparatus 70, and one or more readers 34. The plural client terminals 66 are connected to the step management apparatus 12d over a network 72 such as a LAN. An operator executes post processing such as cutting, bending, and stapling on a print result obtained in the print step by using the postprocessing apparatus 70 while operating the operation terminal 68.

The constituents 110e of the delivery step include plural client terminals 74, the step management apparatus 12e, and one or more readers 34, which are connected through a network 76 such as a LAN.

Next, the management database 30 stored in the memory 20 of the integrated management apparatus 16 is described in detail. As illustrated in FIG. 1, the management database 30 is constituted by one or more job process management sheets 32 that correspond to one or more printed material jobs, respectively. Although three job process management sheets 32a, 32b, and 32c are illustrated in FIG. 1, the number of job process management sheets changes in accordance with the number of printed material jobs. Each of the job process management sheets 32 is, for example, an electronic file. The job process management sheet 32 may be called by a name other than a sheet and can be called, for example, a file, a document, a form, a ledger, a ledger sheet, an electronic ticket, or the like. As is clear from later descriptions, the “sheet” as used herein can be regarded as a record of electronic information (a collection of record information) to which status information acquired from each step management apparatus can be electronically added. Accordingly, the job process management sheet 32 can be regarded as a record on which plural pieces of status information collected in steps of a corresponding print job are recorded.

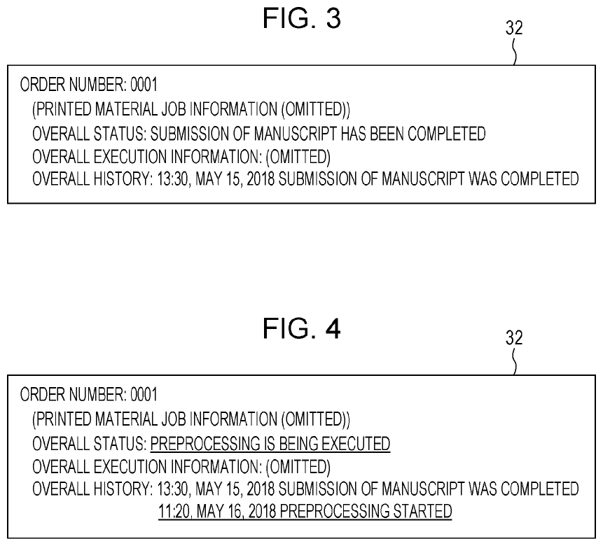

The sheet generating unit 22 of the integrated management apparatus 16 generates the job process management sheet 32 for managing all of the series of steps 100 every time a printed material job is received in an initial one of the series of steps 100. The adding unit 24 of the integrated management apparatus 16 adds a status record to the job process management sheet 32 on the basis of status information included in reports received from the step management apparatuses 12a, 12b, 12c, 12d, and 12e. FIGS. 3 through 9 illustrate an example of the job process management sheet 32 that changes as the steps are performed. FIGS. 3 through 9 are described below in order.

FIG. 3 illustrates an example of the job process management sheet 32 after completion of the manuscript submission step. See FIG. 1 again. When a printed material job is generated in the manuscript submission step, the step management apparatus 12a transmits printed material job information and a report 90a to the integrated management apparatus 16. The printed material job information is, for example, information including an order number, a product ID, a product name, the number of copies, a delivery deadline, an address for delivery, production specifications, and the like. The report 90a is information including contents of execution in the manuscript submission step and status information. The status information is, for example, information including date and time of completion of the manuscript submission step.

Upon receipt of printed material job information from the step management apparatus 12a, the sheet generating unit 22 of the integrated management apparatus 16 generates a new job process management sheet 32 and causes the new job process management sheet 32 to be stored in the memory 20. Note that when a request to produce a printed material is received from a client, the step management apparatus 12a may transmit information on the request to the integrated management apparatus 16, and the sheet generating unit 22 may generate a new job process management sheet 32 on the basis of the information.

Then, the adding unit 24 of the integrated management apparatus 16 makes an addition to the job process management sheet 32 on the basis of the printed material job information and information included in the report 90a received from the step management apparatus 12a. FIG. 3 illustrates a state after the addition is made. As illustrated in FIG. 3, the job process management sheet 32 has an “order number” field, a “printed material job information” field, an “overall status” field, an “overall execution information” field, and an “overall history” field. The adding unit 24 causes the printed material job information received from the step management apparatus 12a to be recorded in the “printed material job information” field. Furthermore, the adding unit 24 adds contents of execution in the manuscript submission step included in the report 90a to the “overall execution information” field. Contents described in the “overall execution information” field and a “group execution information” field that will be described later correspond to step execution information. Furthermore, the adding unit 24 adds date and time of completion of submission of a manuscript to the “overall history” field on the basis of the status information included in the report 90a received from the step management apparatus 12a. As illustrated in FIG. 3, for example, “13:30, May 15, 2018 SUBMISSION OF MANUSCRIPT WAS COMPLETED” is added. Contents described in the “overall history” field and a “group history” field that will be described later correspond to a status record and can be called a log.

The updating unit 26 of the integrated management apparatus 16 updates the “overall status” field on the basis of the status information supplied from the step management apparatus 12a. The “overall status” field shows a current state of a process step. As illustrated in FIG. 3, for example, the “overall status” field is updated to “SUBMISSION OF MANUSCRIPT HAS BEEN COMPLETED”. Contents described in the “overall status” field and a “group status” field that will be described later correspond to a current status. As described above, the presence of the “overall status” field and the “group status” field that will be described later makes it possible to easily grasp a current process step as compared with a case where only a status record is recorded in the job process management sheet 32.

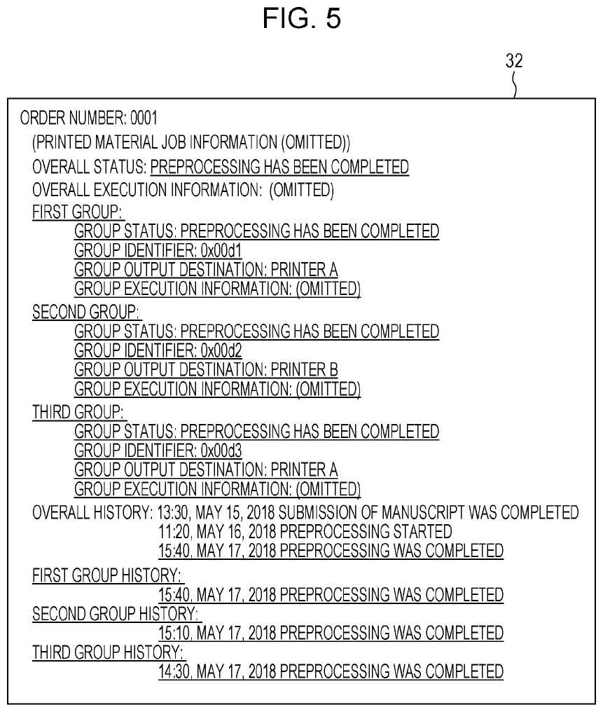

When the production process shifts to the preprocessing step, the step management apparatus 12b in the preprocessing step transmits a report 90b to the integrated management apparatus 16. The report 90b includes status information including date and time of start of the preprocessing step. The adding unit 24 of the integrated management apparatus 16 adds a status record to the “overall history” field of the job process management sheet 32 on the basis of the status information. As illustrated in FIG. 4, for example, “11:20, May 16, 2018 PREPROCESSING STARTED” is added. The updating unit 26 updates the “overall status” field on the basis of the status information received from the step management apparatus 12b. As illustrated in FIG. 4, for example, the “overall status” field is updated to “PREPROCESSING IS BEING EXECUTED”. The underlines in FIG. 4 indicate changes from FIG. 3. In FIGS. 5 through 9 described below, a change from a previous drawing is underlined.

When the preprocessing step is completed, the step management apparatus 12b transmits the report 90b to the integrated management apparatus 16 again. The report 90b received from the preprocessing step can be called preprocessing information. This report 90b includes status information including contents of execution in the preprocessing step and date and time of completion of the preprocessing step. The adding unit 24 adds the contents of execution in the preprocessing step included in the report 90b to the “overall execution information” field. Furthermore, the adding unit 24 adds a status record to the “overall history” field of the job process management sheet 32 on the basis of the status information. As illustrated in FIG. 5, for example, “15:40, May 17, 2018 PREPROCESSING WAS COMPLETED” is added. Furthermore, the updating unit 26 updates the “overall status” field on the basis of the status information received from the step management apparatus 12b. As illustrated in FIG. 5, for example, the “overall status” field is updated to “PREPROCESSING HAS BEEN COMPLETED”.

As described above, in the preprocessing step, in a case where a requested printed material is, for example, a book, component jobs for components such as a “front cover”, a “body”, and a “belly band” are separately generated. That is, the printed material job is separated into plural component jobs. Furthermore, in the preprocessing step, plural group jobs are generated by grouping plural component jobs, and a specific one of plural printers is allocated to each of the group jobs. The following describes an example in which component jobs for components of a “front cover”, a “body”, and a “belly band” are separately generated. For example, a single group job may be generated by grouping two of the three component jobs for the “front cover”, the “body”, and the “belly band”. However, the following discusses an example in which each of the three component jobs is used as a group job as it is (a group job for the “front cover”, a group job for the “body”, and a group job for the “belly band” are generated).

The report 90b transmitted after completion of the preprocessing step includes information on each of the group jobs. In a case where the three group jobs are generated, the report 90b includes three pieces of group job information. The group job information includes contents of execution on a group job in the preprocessing step, identification information of a printer allocated to the group job, and status information such as date and time of completion of the preprocessing step of the group job. The adding unit 24 of the integrated management apparatus 16 creates group job fields corresponding to the respective group jobs on the job process management sheet 32 on the basis of the respective pieces of group job information received from the preprocessing step and records the pieces of group job information in the respective group job fields.

FIG. 5 illustrates a state where three group job fields are created for the three group jobs of the “front cover”, the “body”, and the “belly band” and group job information is recorded in each of the group job fields. In FIG. 5, a first group, a second group, and a third group correspond to the group jobs of the “front cover”, the “body”, and the “belly band”, respectively. In FIG. 5, descriptions below “FIRST GROUP:” are the group job field for the first group (front cover), descriptions below “SECOND GROUP:” are the group job field for the second group (body), and descriptions below “THIRD GROUP:” are the group job field for the third group (belly band).

As illustrated in FIG. 5, each of the group job fields includes a “group status” field, a “group identifier” field, a “group output destination” field, and “group execution information” field. The “group status” field shows a current process step of a group job. The “group identifier” field shows identification information for identifying a group job. The identification information is, for example, given to each group job by the integrated management apparatus 16. The “group identifier” corresponds to identification information included in an RFID tag or a code that will be described later. The “group output destination” field shows an identifier of a printer allocated to a group job. In the “group execution information” field, contents of execution in a step performed on a group job are added.

The adding unit 24 of the integrated management apparatus 16 records a “group output destination” and “group execution information” in each of the group job fields on the basis of the pieces of group job information received from the step management apparatus 12b. Furthermore, adding unit 24 of the integrated management apparatus 16 records a “group identifier” in each of the group job fields. For example, as illustrated in FIG. 5, “0x00d1”, “PRINTER A”, and contents of execution in the preprocessing step performed on the group 1 are recorded in the “group identifier” field, the “group output destination” field, and the “group execution information” field for the group 1 (front cover). Furthermore, the updating unit 26 of the integrated management apparatus 16 updates the “group status” in each of the group job fields on the basis of the pieces of group job information received from the step management apparatus 12b. For example, as illustrated in FIG. 5, the “group status” field of the group 1 (front cover) is updated to “PREPROCESSING HAS BEEN COMPLETED”.

Furthermore, the adding unit 24 of the integrated management apparatus 16 adds a status record of each of the group jobs on the basis of the status information included in the pieces of group job information received from the step management apparatus 12b. For example, as illustrated in FIG. 5, “15:40, May 17, 2018 PREPROCESSING WAS COMPLETED” is added below “FIRST GROUP HISTORY:”.

A timing at which a report is transmitted from each step to the integrated management apparatus 16 is not limited to timings of the start and completion of the step, and a report may be transmitted at any timing, and a report may be transmitted for each group job after the preprocessing step.

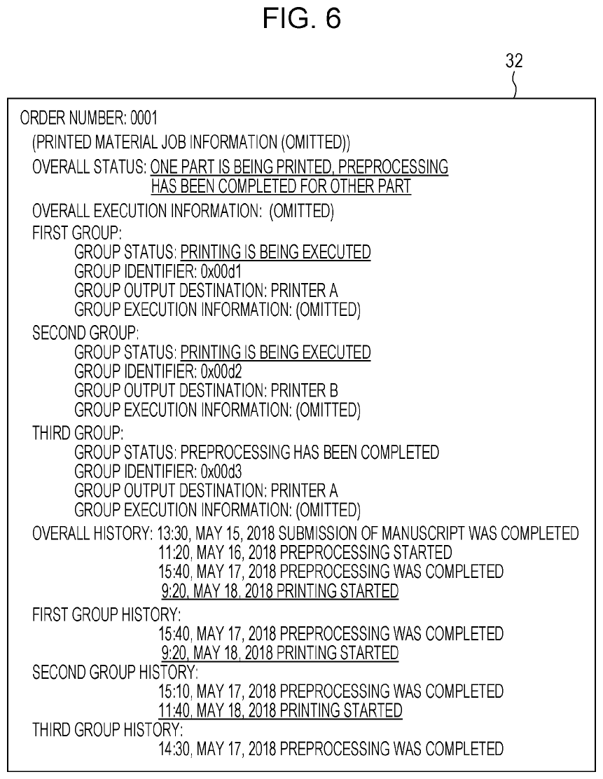

Next, when the production process shifts to the print step, the step management apparatus 12c in the print step transmits a report 90c to the integrated management apparatus 16. The report 90c includes pieces of group job information in addition to information on the whole print process, as in the case of the report 90b in the preprocessing step. In the present exemplary embodiment, the report 90c in the print step is transmitted every time a process state of each group job changes. FIG. 6 illustrates an example of the job process management sheet 32 in a case where a report is transmitted for each of the group jobs from the print step. FIG. 6 illustrates an example of the job process management sheet 32 in a case where the group job of the first group (front cover) is being processed by the printer A, the group job of the second group (body) is being processed by the printer B, and the group job of the third group (belly band) is in a standby state (in a stage in which preprocessing has been completed). On the basis of the report 90c received from the print step, the updating unit 26 of the integrated management apparatus 16 updates the “overall status” of the job process management sheet 32, and the adding unit 24 makes an addition to the “overall execution information” field and the “overall history” field. Furthermore, on the basis of the pieces of group job information included in the report 90c received from the print step, the updating unit 26 of the integrated management apparatus 16 updates the “group status” in each of the group job fields of the job process management sheet 32, and the adding unit 24 adds “group execution information” in each of the group job fields and adds a status record to a history of each of the group jobs. A process step for each of the group jobs in the print step or the postprocessing step that will be described later can be called a group production step.

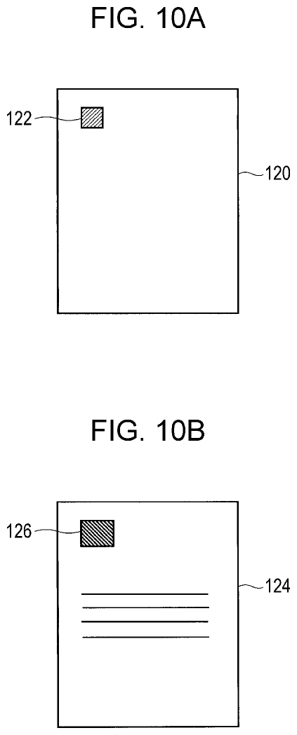

When processes of the respective group jobs are completed in the print step, group print results corresponding to the respective group jobs are completed. Interleaving paper is placed on each of the group print results so that the group print results can be distinguished from each other. FIG. 10A illustrates an example of interleaving paper. In the present exemplary embodiment, the interleaving paper is a sheet of paper 120 given an RFID tag 122. The RFID tag 122 records thereon information on a group job identifier (group identifier) on the job process management sheet 32. For example, “0x00d1”, which is a group job identifier (group identifier) of the first group (a group job of the “front cover”) on the job process management sheet 32 illustrated in FIG. 6 is recorded on the RFID tag 122. As described above, a group job identifier on the job process management sheet 32 and an identifier recorded on the RFID tag 122 are made identical. The integrated management apparatus 16 may use a default ID recorded on the RFID tag 122 as a group job identifier given to a group job on the job process management sheet 32 so that the group job identifier on the job process management sheet 32 and the identifier (the default ID) recorded on the RFID tag 122 become identical.

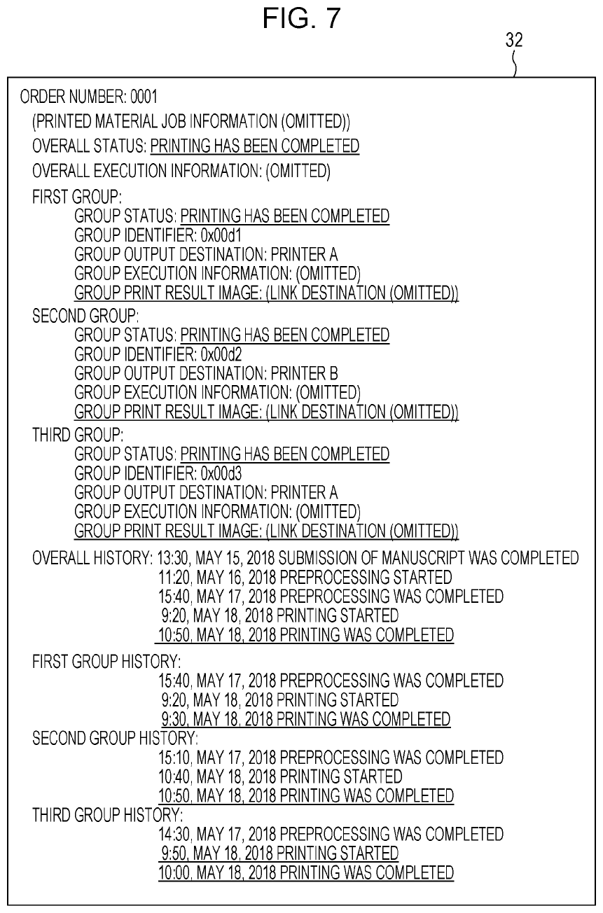

For example, an operator reads the RFID tag 122 on the interleaving paper placed on a group print result by using the reader 34 when printing of a group job is completed. In this way, information (group job identifier information) on a group job identifier recorded on the RFID tag 122 is transmitted to the integrated management apparatus 16 through the step management apparatus 12c. The integrated management apparatus 16 receives the group job identifier information from the reader 34 and grasps to which group job the interleaving paper (the group print result) read by the reader 34 corresponds by comparing the group job identifier information with the group job identifiers (group identifiers) on the job process management sheet 32. That is, the integrated management apparatus 16 specifies, from the job process management sheet 32, a group job having a group job identifier that matches the group job identifier information received from the reader 34. The adding unit 24 of the integrated management apparatus 16 adds a status record such as completion of printing to a history (group history) of the specified group job on the job process management sheet 32. For example, interleaving paper (a RFID tag) on a group print result corresponding to the group job (first group) of the “front cover” is read by using the reader 34, and thus group job identifier information of the first group is transmitted to the integrated management apparatus 16 through the step management apparatus 12c. The integrated management apparatus 16 finds that a target group job is the first group on the basis of the received group job identifier information and, for example, adds “9:30, May 18, 2018 PRINTING WAS COMPLETED” to the first group history field on the job process management sheet 32 as illustrated in FIG. 7 by using date and time of the reading using the reader 34. Furthermore, for example, the integrated management apparatus 16 updates the group status of the first group to “PRINTING HAS BEEN COMPLETED” as illustrated in FIG. 7. In this way, a status record is easily added and a group status is easily updated on the job process management sheet 32 as compared with a case where an operator enters, for example, completion of a process for a group job by using a keyboard or the like of a client terminal or the like. In steps after the print step, in which a physical object (a print result) is present, the print result and the job process management sheet 32 may be associated by using interleaving paper (also called a device ticket) given to the print result. In this way, production of a printed material is accurately managed. The keyhole shaped marks in FIGS. 1 and 2 represent the reader 34. Also in the postprocessing step and the delivery step that follow the print step, an RFID tag of interleaving paper is read by the reader 34, and thus a status record is easily added to the job process management sheet 32, and a status (a group status and an overall status) on the job process management sheet 32 is updated. For example, by reading an RFID tag of interleaving paper by using the reader 34 at a timing of the start of the postprocessing step, a status record indicative of the start of the postprocessing step is recorded on the job process management sheet 32.

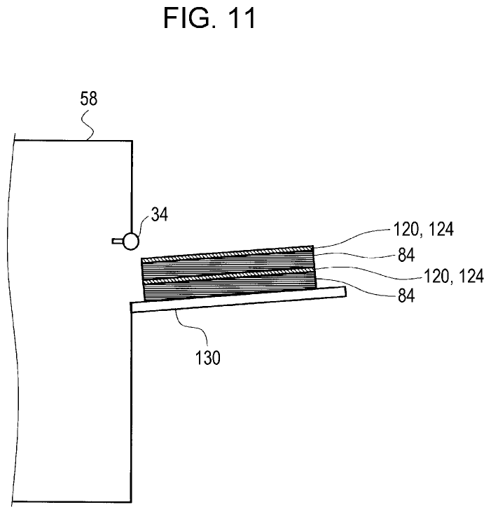

It is easy to place interleaving paper on a group print result in the print step. For example, it is only necessary to place interleaving paper on a paper feed tray different from a paper feed tray on which a sheet of paper for printing of a group job is placed in a printer, feed interleaving paper from the different paper feed tray every time a group print result is output to a paper output tray, and place the interleaving paper on the group print result on the paper output tray. In this case, plural pairs (two pairs in FIG. 11) of group print result and interleaving paper (sheet of paper 120) are sometimes stacked on a paper output tray 130 of the printer 58 as illustrated in FIG. 11. By bringing the reader 34 over these pairs, group job identifier information recorded on even an RFID tag of lower interleaving paper (sheet of paper 120) can be read without problem. The group job identifier information of the RFID tag of the interleaving paper (the sheet of paper 120) can be automatically read when the interleaving paper passes the reader 34 attached to a paper feed port or the like provided before the paper output tray 130 of the printer 58 as illustrated in FIG. 11.

A banner page may be placed on each group print result instead of interleaving paper described above. FIG. 10B illustrates an example of a banner page 124. The banner page 124 is given a code 126 such as a barcode or a QR code (registered trademark). Information on a group job identifier (group identifier) managed on the job process management sheet 32 is recorded on the code 126 instead of an RFID tag. A process similar to that described above can be performed by reading the code 126 by using a reader.

Although a case where a sheet of paper (interleaving paper) given an RFID tag or the banner page 124 given a code is placed on a group print result (an RFID tag or a code is indirectly attached to a group print result), an RFID tag or a code may be, for example, directly attached to a group print result (for example, attached to a margin of the group print result).

FIG. 7 illustrates an example of the job process management sheet 32 after completion of the print step. Conventionally, an image (print result image) obtained by scanning a print result is stored in a server or the like so that the image can be checked afterward. In the present exemplary embodiment, the report 90c received from the print step includes information on a link to a print result image of each group print result. On the basis of the information, the adding unit 24 of the integrated management apparatus 16 adds a link to a print result image (group print result image) of a group print result to each of the group job fields on the job process management sheet 32 as illustrated in FIG. 7.

Next, when the production step shifts to the postprocessing step, the step management apparatus 12d of the postprocessing step transmits a report 90d to the integrated management apparatus 16. The report 90d includes pieces of group job information in addition to information on the overall postprocessing step, as in the case of the report 90c in the print step. The postprocessing step sometimes includes a process (an individual postprocessing step, a group production step) performed beforehand on each of individual group print results in addition to a process (the overall postprocessing step) for combining the group print results. For example, individual postprocessing such as cutting and stapling is performed on a group print result corresponding to the group job of the “body”. Then, the overall postprocessing for generating a printed material (e.g., a book) by combining the “body” on which the individual postprocessing has been performed and the “front cover” and “belly band” that are other components is performed. Since postprocessing of a group job is performed in addition to the overall postprocessing, pieces of group job information are also reported in the postprocessing step.

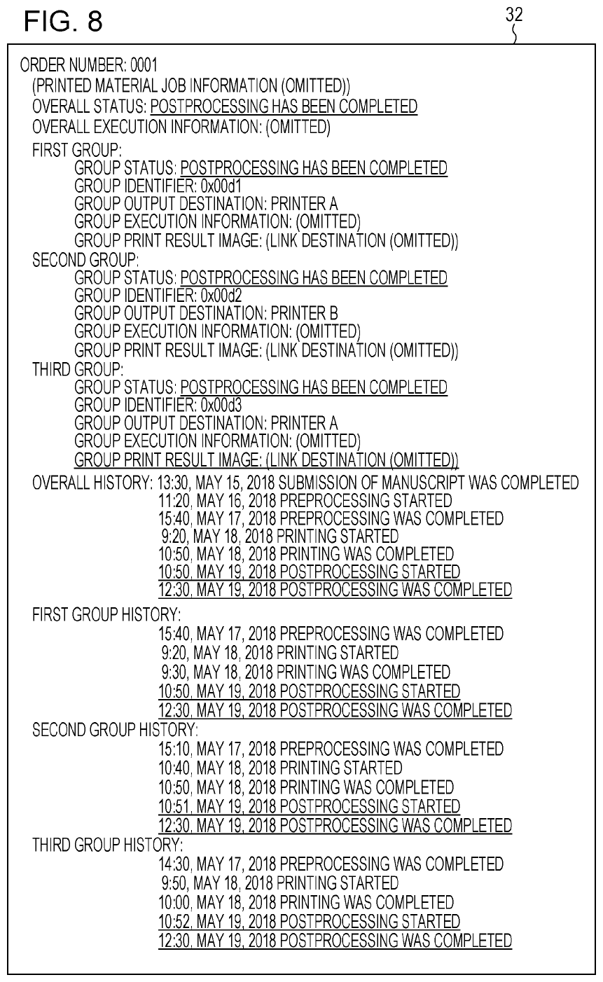

Examples of a timing at which the report 90d is transmitted in the postprocessing step include not only timings of the start and completion of the overall postprocessing step, but also timings of the start and completion of individual postprocessing performed on a group job. FIG. 8 illustrates an example of the job process management sheet 32 after completion of the postprocessing step. On the basis of the report 90d received from the postprocessing step, the updating unit 26 of the integrated management apparatus 16 updates the “overall status” of the job process management sheet 32, and the adding unit 24 makes an addition to the “overall execution information” field and the “overall history” field. On the basis of pieces of group job information included in the report 90d received from the postprocessing step, the updating unit 26 of the integrated management apparatus 16 updates the “group status” in each of the group job fields of the job process management sheet 32, and the adding unit 24 makes an addition to “group execution information” in each of the group job fields and adds a status record to a history of each of the group jobs.

Also in the postprocessing step, an RFID tag of interleaving paper on each of the group print results is read by the reader 34, and thus a status record of each of the group jobs is added to the job process management sheet 32. When a printed material is produced by combining group print results, for example, one of sheets of interleaving paper for the respective plural group print results is placed on the printed material. That is, a group job identifier recorded on an RFID tag of a representative one of the sheets of interleaving paper for the respective plural group print results is used as an identifier of the printed material thereafter. After the postprocessing step, a status record (overall history) of the printed material job is added to the job process management sheet 32 by reading the RFID tag of this interleaving paper by using the reader 34. In the postprocessing step, the components “front cover”, “body”, and “belly band” are combined, and thus a printed material (e.g., a book) is completed.

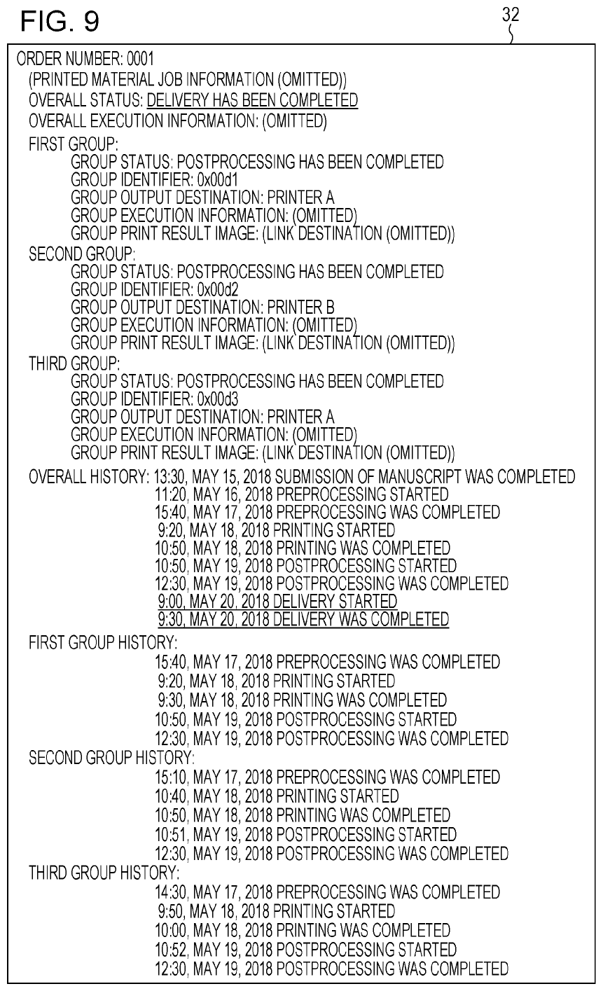

Next, when the production process shifts to the delivery step, the step management apparatus 12e in the delivery step transmits a report 90e to the integrated management apparatus 16. Since there is no group job, information concerning the delivery step of the printed material job (i.e., the overall delivery step) is reported. The report 90e in the delivery step can be transmitted not only at timings of the start and completion of the delivery step, but also at any timing. FIG. 9 illustrates an example of the job process management sheet 32 after completion of the delivery step. On the basis of the report 90e received from the delivery step, the updating unit 26 of the integrated management apparatus 16 updates an “overall status” of the job process management sheet 32, and the adding unit 24 makes an addition to the “overall execution information” field and the “overall history” field.

Also in the delivery step, a status record (overall history) of the printed material job can be added to the job process management sheet 32 and the overall status can be updated by reading the RFID of the interleaving paper placed on the printed material by using the reader 34. For example, an addition or an update can be automatically made to the job process management sheet 32 by attaching the reader 34 in the middle of a transport path along which “the interleaving paper and the printed material” travel on a belt conveyor and automatically reading an identifier of the printed material recorded on the RFID tag when “the interleaving paper and the printed material” pass the reader 34.

The job process management sheet 32 that changes as the steps are performed has been described above. As described above, when each of the step management apparatuses 12a, 12b, 12c, 12d, and 12e transmits, to the integrated management apparatus 16, a request to read out the job process management sheet 32 of a specific printed material job, contents of the job process management sheet 32 are read out (readout 91a, 91b, 91c, 91d, and 91e in FIG. 1). That is, the job process management sheet 32 can be referred to. Specifically, the readout unit 28 of the integrated management apparatus 16 receives a request to read out the job process management sheet 32 from each step management apparatus and reads out the job process management sheet 32 from the memory 20. Since the job process management sheet 32 can be referred to by each step management apparatus, for example, work in each step can be performed on the basis of production specifications included in the “printed material job information” on the job process management sheet 32. Furthermore, information (e.g., overall execution information, group execution information, an overall history, a group history) in other steps can be checked in each step. In this way, for example, a production progress is grasped in each step. Furthermore, in a case where the step management apparatus 12c in the print step refers to a group output destination (an identifier of a printer) in each group job field of the job process management sheet 32, a printer allocated to each group job is grasped.

Although the job process management sheet 32 can be referred to by each step management apparatus in the production integrated management system 200 described above, the job process management sheet 32 may also be referred to by an information processing terminal of an operator who manages progress. Such a case can be considered in which a deadline of delivery of a printed material needs to be met, and an operator grasps in which step the printed material is being processed and makes an adjustment so that the deadline is met. Since progress information (e.g., an overall status, each group status) is managed in the job process management sheet 32, an operator can give an instruction to each step and make an adjustment by referring to the job process management sheet 32 by using an information processing terminal of the operator.

In the above example, component jobs for a “front cover”, a “body”, and a “belly band” are used as group jobs for the “front cover”, the “body”, and the “belly band”. However, plural component jobs may be grouped as a single group job. For example, in a case where there are component jobs for a “front cover”, a “body”, and a “belly band”, the “front cover” and the “belly band” may be grouped as a single group job. The job process management sheet 32 can manage a group job constituted by two or more component jobs instead of a group job constituted by a single component job. In some cases, a component job of one printed material job and a component job of another printed material job are grouped as a single group job. Such a group job existing across products is also managed on the job process management sheet 32. Although three group jobs are managed on the job process management sheet 32 in the above example, one, two, four, or more group jobs are managed in accordance with the number of generated group jobs.

Although group jobs are generated in the above example, a process may be performed in a unit of a printed material job without generating a group job. Even in this case, a production process is managed in an integrated manner by using the job process management sheet 32.

Furthermore, a user sometimes wants to change production specifications of a printed material in the middle of production of the printed material due to various reasons. In this case, the printed material is produced on the basis of the changed production specifications. In such a case, a step management apparatus may report contents, a reason, date and time, and the like of the change to the integrated management apparatus 16, and the integrated management apparatus 16 may record these pieces of information on the job process management sheet 32. For example, a change history field is created when the job process management sheet 32 is generated, and these pieces of information are added to the change history field.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A production integrated management system for a printed material, the production integrated management system comprising:
a plurality of step management apparatuses that manage respective steps of a series of steps that constitute a printed material production process; and
an integrated management apparatus that manages a job process in the printed material production process in an integrated manner on a basis of reports from the respective step management apparatuses,
wherein the integrated management apparatus includes:
a sheet generating unit that generates a job process management sheet for management of all of the series of steps every time a printed material job is received in an initial one of the series of steps; and
an adding unit that adds a status record to the job process management sheet on a basis of status information included in the reports from the respective step management apparatuses.

2. The production integrated management system according to claim 1, wherein
the series of steps include:
a print step in which a plurality of printers are operable in parallel; and
a preprocessing step for separating the received printed material job into one or more component jobs, generating one or more group jobs by grouping the one or more component jobs, and allocating a specific one of the plurality of printers to each of the one or more group jobs; and
the integrated management apparatus creates one or more group job fields corresponding to the one or more group jobs on the job process management sheet and records group job information in each of the one or more group job fields on a basis of preprocessing information received from the preprocessing step.

3. The production integrated management system according to claim 2, wherein
an identifier of the printer allocated to each of the group jobs is recorded in a corresponding one of the group job fields.

4. The production integrated management system according to claim 2, wherein
the series of steps includes one or more group production steps corresponding to the respective one or more group jobs; and
the adding unit adds status records of the respective group jobs to the job process management sheet on a basis of status information included in reports received from the group production steps.

5. The production integrated management system according to claim 3, wherein
the series of steps includes one or more group production steps corresponding to the respective one or more group jobs; and
the adding unit adds status records of the respective group jobs to the job process management sheet on a basis of status information included in reports received from the group production steps.

6. The production integrated management system according to claim 4, wherein
each of the group production steps includes a print step of a corresponding one of the group jobs.

7. The production integrated management system according to claim 5, wherein
each of the group production steps includes a print step of a corresponding one of the group jobs.

8. The production integrated management system according to claim 4, wherein
the job process management sheet includes group job identifiers that are identifiers of the respective group jobs;
group print results obtained after the print step that correspond to the respective group jobs are each directly or indirectly given a code or a tag having group job identifier information that is information on a corresponding one of the group job identifiers; and
the adding unit adds status records of the respective group jobs to the job process management sheet by comparing the group job identifier information received by reading the code or the tag by using a reader in a step after the print step with the group job identifiers on the job process management sheet.

9. The production integrated management system according to claim 5, wherein
the job process management sheet includes group job identifiers that are identifiers of the respective group jobs;
group print results obtained after the print step that correspond to the respective group jobs are each directly or indirectly given a code or a tag having group job identifier information that is information on a corresponding one of the group job identifiers; and
the adding unit adds status records of the respective group jobs to the job process management sheet by comparing the group job identifier information received by reading the code or the tag by using a reader in a step after the print step with the group job identifiers on the job process management sheet.

10. The production integrated management system according to claim 6, wherein
the job process management sheet includes group job identifiers that are identifiers of the respective group jobs;
group print results obtained after the print step that correspond to the respective group jobs are each directly or indirectly given a code or a tag having group job identifier information that is information on a corresponding one of the group job identifiers; and
the adding unit adds status records of the respective group jobs to the job process management sheet by comparing the group job identifier information received by reading the code or the tag by using a reader in a step after the print step with the group job identifiers on the job process management sheet.

11. The production integrated management system according to claim 7, wherein
the job process management sheet includes group job identifiers that are identifiers of the respective group jobs;
group print results obtained after the print step that correspond to the respective group jobs are each directly or indirectly given a code or a tag having group job identifier information that is information on a corresponding one of the group job identifiers; and
the adding unit adds status records of the respective group jobs to the job process management sheet by comparing the group job identifier information received by reading the code or the tag by using a reader in a step after the print step with the group job identifiers on the job process management sheet.

12. The production integrated management system according to claim 1, wherein
the adding unit adds step execution information to the job process management sheet on a basis of contents of execution in the steps included in the reports received from the respective step management apparatuses.

13. The production integrated management system according to claim 1, wherein
the job process management sheet is referable from the step management apparatuses.

14. The production integrated management system according to claim 1, wherein
the job process management sheet includes a current status indicative of a current process step; and
the integrated management apparatus includes an updating unit that updates the current status on a basis of status information included in the reports from the respective step management apparatuses.

15. The production integrated management system according to claim 2, wherein
the series of steps includes a postprocessing step that follows the print step; and
in the postprocessing step, a printed material is produced by combining a plurality of components that correspond to the plurality of component jobs.

16. A production integrated management apparatus for a printed material, the production integrated management apparatus comprising:
a sheet generating unit that generates a job process management sheet for management of all of a series of steps that constitute a printed material production process every time a printed material job is received in an initial one of the series of steps; and
an adding unit that adds a status record to the job process management sheet on a basis of status information included in reports from of a plurality of respective step management apparatuses that manage respective steps of the series of steps.

17. A non-transitory computer readable medium storing a program causing a computer to execute a process, the process comprising:
generating a job process management sheet for management of all of a series of steps that constitute a printed material production process every time a printed material job is received in an initial one of the series of steps; and
adding a status record to the job process management sheet on a basis of status information included in reports from a plurality of respective step management apparatuses that manage respective steps of the series of steps.
